(19) United States
(12) Patent Application Publication
(10) Pub. No.: US 2005/0276898 A1
(43) Pub. Date: Dec. 15, 2005

(54) Aerated creamers and processes

(76) Inventors: Teresita Bautista Pascual, Marysville, OH (US); Janejira Surintrspanont, Bangkok (TH)

Correspondence Address: WINSTON & STRAWN LLP, 1700 K STREET, N.W., WASHINGTON, DC, 20006, US

(21) Appl. No.: 11/151,539

(22) Filed: Jun. 14, 2005

Related U.S. Application Data
(60) Provisional application No. 60/579,267, filed on Jun. 15, 2004.

(51) Int. Cl. A23F 5/00

(52) U.S. Cl. 426/594

(57) ABSTRACT

Foamed liquid creamers including first and second components that cooperate when combined with a water-containing beverage to cream the beverage while forming a foam layer thereon, with a portion of the foam layer residing on the beverage and the remainder at least partly melting or dispersing in less than about 20 seconds after combination with the beverage to provide a whitening color and creamer flavor to the beverage. The liquid creamer, and methods of making and using the same, typically includes a liquid component containing entrapped gas, such as air. The amount of foam generated in the beverage is dependent on the overrun of the foaming liquid creamer.

### CROSS-REFERENCE TO RELATED APPLICATION

This application claims the benefit of U.S. Provisional Patent Application No. 60/579,267, filed Jun. 15, 2004, the entire contents of which is incorporated herein by express reference thereto.

### FIELD OF THE INVENTION

The invention relates to natural-like foamed whitening liquid creamers, and methods of making and using the same. More particularly, it relates to foamed gas-containing natural-like liquid creamers and methods.

### BACKGROUND OF THE INVENTION

A variety of methods are known for producing a foam layer on top of beverages, such as coffee. A primary example is the standard cappuccino coffee. Cappuccino-style coffees have a lower layer made of a coffee beverage and an upper layer of steamed frothy milk or cream. The coffee layer is made first and put into the beverage container and then the milk or cream is steamed and aerated to produce a froth or foam which is poured on the coffee layer. Other specialty coffee drinks are made similarly. Such methods of producing coffee drinks are usually encountered in restaurant or coffee shops and require specialized equipment. Furthermore, preparation of such drinks requires a skilled operator and is time consuming.

Thus, many products, such as foaming creamers and foaming beverages have emerged in the marketplace to fill the need of the coffee drinker. With the increased popularity of coffeehouses and coffee, even more foaming and creamer products have been introduced. Some of them are detailed below.

Conventional dry mix instant hot cappuccino compositions include a coffee component, a foaming creamer component, an optional sweetener component, together with other optional compositions such as flavor, color, and foam stabilizer components. The compositions are typically provided as a particulate powder or granulate composition in a hot liquid, such as water or milk. Sweetener, if not present in the composition, is normally added when the beverage is prepared. Hot cappuccino beverages have a substantial and characteristic foam on the top surface of the beverage usually provided by steamed milk in brewed cappuccinos and by particulate dry mix foaming creamers in instant cappuccinos.

Foaming beverages are popular because the whole beverage, complete with foam, is prepared in a single step, such as in instant cappuccino-style coffees. Such beverages are described in U.S. Pat. No. 5,882,716, U.S. Pat. No. 6,048,567, U.S. Pat. No. 6,174,557, U.S. Pat. No. 6,290,997, U.S. Pat. No. 6,569,486, U.S. Publication No. 2003/0157235, U.S. Publication No. 2003/0219522, International Publication No. WO 00/56163, and JP Publication No. 2003-000210. These pre-formed foaming beverages, however, do not allow the consumer the flexibility of tailoring the beverage according to personal preferences, such as the type of coffee or other beverage used. In addition, many coffee drinkers prefer fresh brewed coffees over instant coffee or coffee from concentrate.

U.S. Pat. No. 5,350,591 discloses a foaming creamer composition, in the form of a dry powdered mixture that contains components for generating carbon dioxide. EP 0,796,562 discloses a particulate dry mix foaming creamer that does not require incorporation of a gas for creating cappuccino foam. The foam is instead obtained by mixing gluconolactone and an alkali metal carbonate or bicarbonate. This foaming creamer can be used with dry mix soluble coffee produce or liquid beverages such as brewed coffee. It is said that all additives other than gluconolactones either cause formation of floating aggregates or suffer from incomplete solubility with resultant precipitation, saltiness, or other apparent flavor or texture changes, insufficient acidity to drive reaction with bicarbonate to generate adequate foam, or insufficient acidity to maintain original beverage pH.

Other dry creamer formulations that include a foaming agent are also widespread. Powdered or dry creamer formulations are described in U.S. Pat. No. 4,438,147, U.S. Pat. No. 5,462,759, U.S. Pat. No. 5,721,003, U.S. Pat. No. 5,780,092, U.S. Pat. No. 6,129,943, U.S. Pat. No. 6,168,819, U.S. Pat. No. 6,589,586, U.S. Publication No. 2002/0018839, U.S. Publication No. 2002/0127322, International Publication No. WO 97/25882, International Publication No. WO 03/041506, EP 0813815, EP 0885566, and JP Publication No. 08-038048. Problems associated with dry formulations include the disruption of the physical integrity or structure of the dry product that occurs during normal shipping and handling, such as when moisture contacts the dry powder. Such structural disruption often leads to less than desirable foaming properties and less than appealing sensory characteristics that detract from the freshness and appeal of the beverage.

Thus, some other types of creamers have been formulated. For example, U.S. Pat. No. 6,713,114 discloses a frozen beverage topping composition which results in a frothy or foam layer over a beverage. The beverage topping composition provides creaming and can flavor, sweeten, and slightly cool coffee and other beverages. The addition of the beverage itself produces the foam. Also, U.S. Publication No. 2004/0062846 discloses powdered and liquid, dairy and non-dairy creamer compositions. These creamer compositions can be prepared in both concentrated and ready-to-use forms, and may optionally include foaming agents.

Frequently, many of the foaming creamers in the prior art produce a brown or speckled colored foam, instead of a white foam. A brown foam detracts from the coffee-drinking experience. On the other hand, a white foam enhances the experience by allowing the drinker to feel like the beverage was produced with fresh ingredients, and perhaps in a traditional coffeehouse in the traditional way, i.e., with an espresso machine. Also, known foaming creamers can produce foam in hot beverages but none are known for use in cold beverages. Thus, there remains a need for a fresh and naturally foaming liquid creamer that provides a white foam when added to a liquid beverage of any temperature and that additionally provides a whitening color and creamer flavor to the beverage.

### SUMMARY OF THE INVENTION

The present invention relates to foamed liquid creamer comprising first and second components that cooperate when combined with a water-containing beverage to cream the beverage while forming a foam layer thereon, with a portion of the foam layer residing on the beverage and the remainder at least partly melting or dispersing in less than about 20 seconds after combination with the beverage to provide a whitening color and creamer flavor to the beverage. Preferably, the liquid creamer is natural-like. The foam layer has a density of less than the beverage so as to reside upon the beverage. In a preferred embodiment of the present creamer, one of the components includes a liquid whitening component while the other component includes sufficient entrapped gas to facilitate formation of a foam layer. In a preferred embodiment, each of these components is refrigerator stable.

In one embodiment, the creamer has a sufficiently thick viscosity to be spooned onto the beverage. In another embodiment, the creamer is pourable. In one preferred embodiment, the foam layer has a density that is less than that of the beverage so that the foam layer can reside upon the beverage. In a preferred embodiment, the portion that imparts a creaming effect and whitens the beverage is uniformly dispersed within the beverage. The entrapped gas component helps lower the density of the foam layer and facilitates foam formation. Preferred beverages include tea, coffee, chocolate, aromatized dairy beverages, or a combination thereof. In one embodiment, the first and second components form a homogenized mixture that includes water, vegetable oil, a protein component, and an emulsifier component to form the foamed creamer. In a preferred embodiment, the emulsifier component includes at least one of a mono diglyceride, di-acetyl tartaric acid ester monoglyceride (DATEM), or stearoyl lactylate. In different embodiments, the creamer of the invention can be a non-dairy creamer or a dairy creamer. The creamer can also have the first and second liquid components enclosed in one compartment of a single package. In a preferred embodiment, the liquid components are refrigerator stable as is the creamer product. Optionally, conventional containers can be used to package the creamer of the invention. For example, this can be a non-pressurized container, preferably a plastic bottle.

Optionally, the creamer can be thermally processed with subsequent cooling and incorporation of gas into the liquid whitening component. A process for the manufacture of the foamed liquid creamer includes chilling the creamer sufficiently to cool the creamer while retaining at least a portion of the foam, and incorporating an amount of gas into the creamer sufficient to create foaming and form a foam. In a preferred embodiment, the chilling occurs then the incorporating. The process may also include disposing the gas-foamed creamer in a non-pressurized container.

The invention also encompasses a vending machine that includes and dispenses a plurality of products at least one of which is the creamer previously described.

The invention further encompasses methods for providing a whitened beverage product having a perceived fresh upper foam layer by combining with a water-containing beverage a liquid creamer that provides a foam in the beverage and that disperses throughout the beverage to whiten the beverage after being combined therewith, and allowing the foam to rise to form an upper foam layer on the beverage. In one embodiment, the creamer disperses throughout the beverage in less than about 20 seconds after being combined therewith.

The invention also encompasses a ready-to-use, refrigerator-stable, foamed liquid creamer that includes container and a creamer according to the invention. In a preferred embodiment, the creamer includes first and second liquid components such that a portion of the creamer provides a foam layer and, when combined with a water-containing beverage, the remainder of the creamer partly melts or disperses in less than about 20 seconds after combination with the beverage to provide a whitening color and creamer flavor to the beverage and the foam layer has a density of less than the beverage so as to reside upon the beverage. In a preferred embodiment, one of the components includes a liquid whitening component while the other component includes entrapped gas, and wherein the first and second components are refrigerator-stable.

### BRIEF DESCRIPTION OF THE DRAWINGS

Further features and advantages of the invention can be ascertained from the following detailed description that is provided in connection with the drawing(s) described below:

FIG. 1 illustrates the foaming and whitening properties of a creamer according to the present invention, when added to a hot cappuccino coffee-beverage.

### DETAILED DESCRIPTION OF THE PREFERRED EMBODIMENTS

The present invention surprisingly and unexpectedly provides a natural-like liquid creamer that includes a white foamed creamer that whitens and provides a creamer flavor to a beverage, thereby enhancing the visual appeal, the flavor, and the texture of the beverage. The white foam provided by the creamer is preferably similar, both visually and in taste and smell, to the steamed and foamed milk traditionally placed on top of cappuccino-style beverages. The creamer, however, is typically provided ready-to-use and is readily dispersible in both hot and cold beverages to provide a whitening effect and creamer flavor, and produces a white foam without the use of complicated equipment or machinery. Beverages that may be used in combination with the creamer include, for example, coffee, tea, chocolate, liquor, soup, juice, and the like, or any combination thereof (e.g., tea and lemonade, or coffee and liquor). Preferred beverages include tea, coffee, or hot chocolate, or a combination thereof.

Accordingly, the present invention relates to a self-foaming, liquid creamer that includes a first and second component such that a portion of the creamer provides a foam layer and, when combined with a water-containing beverage, the remainder of the creamer partly melts or disperses in less than about 20 seconds to provide a whitening color and creamer flavor to the beverage. The creamers of the invention are preferably natural-like, i.e., approximate the texture and appearance of foamed natural products like milk or cream. Natural-like should also be understood to include a processed creamer that has an improved stability over natural products to increase convenience in preparing and storing such creamers compared to a conventional coffeehouse product such as steamed milk. The natural-like products of the invention will have a perceived organoleptic characteristic that is at least equivalent to such conventional coffeehouse products. The foam layer has a density of less than the beverage so as to reside upon the beverage. The foamed creamer typically has a density of about 0.5 g/cm³ to 0.9 g/cm³, preferably about 0.6 g/cm³ to 0.8 g/cm³.

In one simple step, a beverage drinker combines a creamer with a beverage to improve the flavor and texture of the beverage, modify the color of the beverage it is combined with, and at the same time, provides a foam or frothy layer of gas-entrapped within liquid on the top surface of the coffee. Providing a natural-like creamer in liquid form that functions similarly to the flavor, color, and texture benefits of a foamed natural milk enhances a consumer's perception of the beverage as both fresh and natural, and decreases the time a consumer must wait to enjoy the hot or cold beverage. The freshness can be achieved by using creamer components that do not tend to denature, i.e., the natural-like creamers of the invention can be substantially free or entirely free of proteins or other components that denature. Thus, even components from milk, cream, or other natural components can be included in forming the creamer of the invention. Advantageously, a consumer can turn a homemade cup of, e.g., coffee into a coffeehouse-style gourmet beverage, with a rich texture, whitening effect, and a visible foam layer. The amount of foam generated by the foamed creamer will be determined by the amount of overrun and can be readily determined and selected by those of ordinary skill in the art, particularly with reference to the description of the invention herein.

The creamer may be a dairy or non-dairy creamer. Thus, another surprising and unexpected advantage of the present invention is that a natural-like non-dairy creamer can be provided that approximates the whitening, foaming, and flavor of a fresh dairy creamer. This advantageously benefits those who prefer to minimize or avoid the intake of dairy products, e.g., lactose intolerant persons, or the like. Additionally, the liquid creamers of the present invention, whether dairy or non-dairy, desirably may have a longer shelf-life compared to fresh milk or cream. The inventive creamers can be stored with or without refrigeration, although preferably the creamer is refrigerator-stable. Refrigeration is typically required to retain sufficient gas entrapped within the liquid creamer of the invention to facilitate foam formation. Under refrigeration, the creamers are formulated to be suitable for long-term storage, for example, for at least about 3 months, preferably at least about 6 months. The natural-like liquid creamers of the claimed invention can even include a portion of certain components of fresh milk if desired, or the creamers can be substantially or entirely free of the perishable components typically found in fresh milk to increase shelf-life while maintaining the foaming, whitening, and flavor enhancing benefits of a natural creamer. The creamer of the invention can also be at least substantially fat-free, or preferably entirely fat-free, to provide the flavor, texture, and visual benefits of a real creamer without adding unhealthy fat content. In a preferred embodiment, the creamer can also contain ascorbic acid and therefore it can be a source of water soluble vitamin.

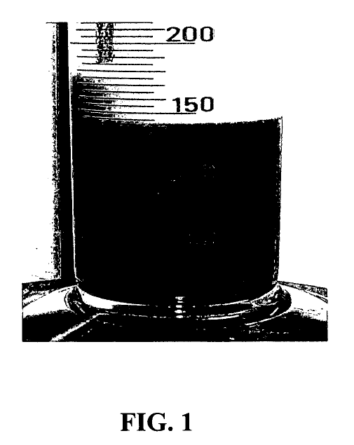

FIG. 1 illustrates both the foaming and whitening effects of the creamer when added to a hot cappuccino beverage. It should be understood for all embodiments of the invention that the liquid creamer may be provided to a drinking container first, followed by the beverage; by the beverage first and then the liquid creamer; by alternating portions of beverage and creamer; or any other suitable method for combining the beverage and creamer.

Typically, the liquid creamer of the invention includes at least one-liquid component with entrapped gas, e.g., air, nitrogen gas, or the like. The system contains at least two components: a liquid and a gas. When added to the beverage, this foamed creamer disperses to whiten the beverage. At the same time, the entrapped gas creates a foam head on the beverage.

The invention encompasses this liquid, gas-containing foaming creamer that already contains the aeration and thereby can avoid the need for a two- or more liquid system to generate foam. In this embodiment, a portion of the foam, when added to a beverage, disperses in the beverage to impart a creaming effect to the beverage and to whiten the beverage so as to modify the color and flavor thereof. The remainder of the gas-containing foam resides on top of the beverage as a visible foam layer. As used herein, “white” refers to the color of milk, cream, or the like, and can include beige or other off-white colors. The term “disperses” includes the possibilities that, e.g., the foam melts or dissolves, within the beverage.

An exemplary gas-containing liquid creamer includes a homogenized mixture of water, vegetable oil, protein component, emulsifier component, or a combination thereof. Preferably, the creamer further includes one or more of the following: bulking agents, stabilizer component, buffer salt component, additives such as colors and flavors. A preferred creamer of the invention includes at least one material from each of these categories. The bulking agent preferably includes sucrose, maltodextrin, corn syrup solids from DE 18 to 42, or a combination thereof. The vegetable oil typically includes any suitable oil or blend thereof, preferably those having a melting point range from about 32° C. to 43° C. The protein component preferably includes one or more of caseinate, nonfat dry milk, soy protein, or a combination thereof. The emulsifier component preferably includes one or more mono diglycerides, di-acetyl tartaric acid ester monoglyceride (DATEM), stearoyl lactylate, or any other emulsifier discussed herein, or a combination thereof. The stabilizer component preferably includes one or more gums such as carrageenans, microcrystalline cellulose gum, or a combination thereof.

Significantly, the gas that is used to create the foamed creamer is preferably just air, instead of nitrous oxide. Air is more preferred than any other gas, although nitrogen gas is suitable as well. Nitrous oxide, used for various conventional aeration processes in making ice cream and other aerated products, can cause serious injury if not handled properly. The use of air or nitrogen gas instead of nitrous oxide-containing gases allows the use of simpler equipment, simpler manufacturing procedures, and simpler packaging. Moreover, it substantially or completely reduces the need for any warning labels on the packaging or container that contains the creamer of the invention.

The gas-containing foamed or foaming creamer can be prepared by incorporating an amount of gas into the creamer sufficient to create foaming and form a foam. The creamer is sufficiently chilled to cool the creamer so it retains at least a portion of the foam. Typically, the chilling occurs before the aeration or incorporation of gas. Generally, the creamer is manufactured by first mixing together the components of the creamer, such as water, creamer components, and sweeteners. The mixture is then preferably pasteurized and homogenized, cooled, and then aerated. It can optionally be further chilled or the chilling can be maintained, e.g., to assist in retaining the aeration or to prolong stability, for any length of time until it is ready to be thawed/warmed or directly added to a beverage. The pasteurized mix is preferably aerated prior to cooling to allow the vegetable oil component to crystallize, which facilitates the aeration process. Aeration may be accomplished by a variety of methods known to those of ordinary skill in the art. A preferred method of aerating the mixture is with a high shear pressurized mixture, such as an Oakes™ continuous mixer. Other mixers, like a Hobart mixer, are also suitable.

The gas-containing foamed liquid natural-like creamer is prepared as follows. The mixture of components is preferably pasteurized or otherwise heat treated, cooled to 40° F. for at least about one hour, and gassed to a suitable overrun depending on the texture of the finished product, i.e., from pourable to spoonable. The pourability of the product decreases with increasing overrun. For example, the creamer may be in a form that is pourable, such as a foam or foam-containing liquid, or it may have a sufficiently thick viscosity to be spooned or sprayed onto the beverage, like a traditional whipped cream. As used herein “sufficiently thick viscosity” refers to a form of the creamer that remains on a spoon for at least half a second, preferably at least one second, when the spoon is turned upside down. The term “pourable” refers to a creamer with sufficiently low viscosity that at least a substantial portion of the creamer will readily flow out of a container when poured or, e.g., flow readily off of a spoon in less than 0.1 seconds when turned upside down. Air or any inert gas such as nitrogen gas is incorporated into the pasteurized liquid creamer via any suitable mixer, i.e., Aeromixer, Oaks Mixer. The gas-containing foaming creamer may thus be prepared with varying amounts of gas to form products with different viscosities. The foamed liquid creamer is preferably aerated or gassed from about 25% to 200% overrun, more preferably from about 50% to 150% overrun.

The portion of the natural-like liquid creamer that imparts a creaming effect and whitens the beverage is preferably at least substantially dispersed, and more preferably entirely dispersed within the beverage. In a most preferred embodiment, the portion is uniformly dispersed within the beverage. Conventional whipped cream toppings generally do not disperse in beverages, and thus do not impart a whitening effect to the beverage as a whole. The creamer described herein, however, provides a foam that both disperses in beverages to impart a whitening effect and desirable flavor modification to the beverage, while modifying the texture of the beverage and creating a foam layer. Moreover, unlike frozen creamers, the liquid nature of the creamers of the present invention facilitates dispersion through a beverage to provide a creaming and whitening effect.

Optionally, the creamer can include sweeteners and/or flavorings. The sweetener may be a non-caloric, low caloric, or caloric sweetener. Sweeteners impart a wide range of overall sweetness to the creamer. Non-caloric or low-caloric sweeteners generally include a high intensity sweetener and a bulking agent. Bulking agents can help maintain the overall structure and integrity of the creamer while imparting little or no sweetness. Caloric sweeteners generally include sugars or mixtures of sugars, such as fructose, sucrose, dextrose, maltose, lactose, high fructose corn syrup solids, invert sugar, sugar alcohols, and the like, as well as mixtures of these sweeteners. Flavorings can be used to deliver one or more specific flavors to the beverage. These flavorings may be natural or artificial in origin. Preferred flavors, when used in the creamers of the invention, include amaretto, almond nut, anisette, brandy, mint, chocolate, cinnamon, cinnamon almond, mocha, vanilla, toffee, cappuccino, lemon, macadamia nut, orange, peach, strawberry, grape, raspberry, cherry, coffee, and the like, and mixtures thereof. The addition of flavorings to the creamer further enhances the coffee-drinking experience. Preferably, all components of the creamer, beverage, and combination thereof, will be substantially or entirely soluble.

Because the creamer of this gas-containing foaming creamer embodiment is already foamed when placed inside the container, it does not require a pressurized container, such as an aerosol can, to produce the foam. Consequently, the creamer can be packaged in less expensive and more environmentally-friendly containers, such as a non-pressurized container. Frequently, aerosol cans also include environmentally harmful chemicals, typically propellants, such as chlorofluorocarbons, that can damage the ozone layer. Use of a non-pressurized container aids in the preservation of the environment and its resources.

The invention also includes packaging or a container including a creamer of the invention. The creamers can be packaged for use, and each package can hold a sufficient amount of the first and second creamer components for a single serving, or for multiple servings, or even for bulk use or food service usage. The single-serve or multi-serve packages can optionally be packed into a multi-packaged cases or cartons for shipment and sale to supermarkets, convenience stores, or the like. The package may be in the form of compartmentalized can, carton, jar, bottle, cup, or any other conventional or disposable containers used to hold liquids. For example, the container can be a plastic bottle, and preferably, a multi-layer plastic bottle. Any suitable plastic or polymer material or a combination thereof may be used to form the plastic bottle. Examples include polyesters, polyvinyl chlorides, polyethylenes, and polypropylenes. Preferably, one or more polyolefinic materials is used. In one preferred embodiment, the package is a bottle that is rigid or squeezable. In one embodiment, the creamer can be part of a vending machine suitable for the delivery of dairy or non-dairy creamer.

The liquid creamers can be preferably packaged in a non-pressurized container, i.e., they do not require pressurization for shipping, storage, or the like. Non-pressurized typically means at or about ambient pressure, and preferably non-pressurized creamers are at least substantially or entirely free of propelling gas, e.g., nitrous oxide, as this is unnecessary for foam formation. This can surprisingly permit the use of conventional packaging for foamed creamer products of the invention as noted above. Preferably, the container can minimize or even avoid the need for special coatings, foil packaging, vacuum-packing, or other special freshness-preserving efforts, as a non-pressurized container will typically provide suitable refrigerator stability to the foamed creamer of the invention. Preferably, the packaging of the creamer is a non-pressurized bottle or can or box of any suitable food-grade material or a multi-layer material with the innermost layer being made of food-grade material. An exemplary package is a non-pressurized bottle. The creamer can be packaged so that the consumer can simply open the package and add the foamed creamer to the beverage. This embodiment can be suitable for placement and sale in vending machines.

The shelf life of the gas-containing liquid creamer is at least about 60 days, preferably at least about 90 days, and more preferably at least about 120 days at refrigerated temperatures. Refrigerated temperatures generally include those less than about 10° C., preferably less than about 6° C., while ambient temperature is considered to be 20° C. The creamers of the invention are typically stored at temperatures greater than freezing (0° C.) to facilitate their presence in liquid form.

In one embodiment, the creamer of the present invention is substantially free of, and preferably entirely free of, fat/oil microparticulates or emulsifiers, or both. In this embodiment, advantageously, the creamer does not require an emulsifier to readily disperse in the hot or cold beverage.

The invention may also include a set of instructions for preparing a beverage in a drinking container, which includes instructions (such as on a label, packaging, or an insert), to dispose a caffeinated beverage into a selected drinking container, and to dispose a liquid, foamed, natural-like creamer into the drinking container. Either order of disposing the beverage and creamer may be specified. The disposing of the beverage or the natural-like creamer liquid is preferably sufficient to disperse the creamer throughout the beverage without a spoon. The set of instructions may be displayed, for example, on the package for the creamer. In one embodiment, such as for the foamed gas-containing natural-like liquid creamer, it is preferred that the beverage is at least about 100° C. to facilitate foaming and/or dispersion. In another embodiment, a lower viscosity foamed creamer can be formulated to facilitate foaming and dispersion even in a cold beverage, e.g., one at ambient temperature or even chilled to refrigerator temperatures.

The invention also encompasses various delivery methods and equipment, such as vending machines, for delivering the foamed natural-like liquid creamers of the present invention. In one embodiment, the invention encompasses a vending machine that includes and dispenses a plurality of products at least one of which is the creamer previously described. Other products included in the vending apparatus can include any suitable beverage or components thereof.

### EXAMPLES

The following examples are not intended to limit the scope of the invention, but merely to illustrate representative possibilities concerning the present invention.

### Example 1

### Preparation of Hot Cappuccino Beverage According to the Invention

Hot cappuccino beverages were prepared by adding to about 120 mL of dark coffee, prepared from dehydrated Nescafé Gold instant coffee with the dairy foam of the invention being obtained by mixing 20 mL of acidified whey powder aqueous solution with a pH of about 4.5, and having a total solid content of about 40%, and 20 mL of alkalinized skim milk powder solution containing about 2% of potassium bicarbonate and a total solid content of about 40%.

### Example 2

### Preparation of Hot Cappuccino Beverage According to the Invention

Hot cappuccino beverages were prepared by adding to about 120 mL of dark coffee, prepared from dehydrated Nescafe Gold instant coffee with the dairy foam of the invention being obtained by mixing 20 mL of acidified whey powder aqueous solution with a pH of about 3.7, and having a total solid content of about 40%, and 20 mL of alkalinized skim milk powder solution with a pH of about 7.4, containing about 2.5% of potassium bicarbonate and a total solid content of about 20%.

### Example 3

### A Foamed Non-Dairy Creamer of the Invention

A foamed creamer prepared according to the invention was reconstituted into coffee with temperatures of: 160° F., 140° F., 120° F., 100° F., 80° F., 70° F., and 38° F. The creamer had good solubility when added to coffee at temperature ≧100° F. (˜38° C.). The creamer went into solution with minimal stirring (˜7 stirs) and there were no lumps observed. The foam had a light beige to white color, and lasted for more than 20 minutes.

The foamed creamer was reconstituted according to the invention with the following components:

| Composition | Amount (%) |
|---|---|
| Water | 44.75 |
| Hydrogenated Coconut Oil | 22.00 |
| Sucrose | 30.00 |
| Sodium Caseinate | 2.20 |
| DATEM | 0.30 |
| Distilled Monoglyceride | 0.20 |
| Disod. Phosphate (anhydrous) | 0.50 |
| Carrageenan | 0.05 |
| Total | 100 |

This creamer was aerated to 90% overrun and had a density: 0.7 g/ml. Upon reconstitution in a beverage, 18 grams of the foaming creamer was added to 180 ml of 1.2% soluble coffee, which provided good solubility and good foam head generated at temperatures over 100° F. Foam stability in the beverage lasted for more than 20 min. Other aeration levels were tested and this creamer formulation was pourable at an overrun of less than about 115%. The foam head provided had a height of about 2 cm to 3 cm for a conventional coffee cup or mug.

### Example 4

### A Foamed Dairy Creamer of the Invention

A foamed dairy creamer can be prepared according to the invention for reconstitution into coffee with temperatures of: 160° F., 140° F., 120° F., 100° F., 80° F., 70° F., and 38° F. The creamer has good solubility when added to coffee at temperature ≧100° F. (˜38° C.). The creamer goes into solution with minimal stirring (˜7 stirs) and there will be no lumps observed. The foam has a light beige to white color, and lasts for more than 20 minutes.

The foamed creamer is reconstituted according to the invention with the following components:

| Composition | Amount (%) |
|---|---|
| Water | 44.75 |
| Hydrogenated Coconut Oil | 22.00 |
| Sucrose | 27.20 |
| Skim Milk Powder | 5.00 |
| DATEM | 0.30 |
| Distilled Monoglyceride | 0.20 |
| Disod. Phosphate (anhydrous) | 0.50 |
| Carrageenan | 0.05 |
| Total | 100 |

This creamer is aerated to 90% overrun and will have a density: 0.7 g/ml. Upon reconstitution in a beverage, 18 grams of the foaming creamer are added to 180 ml of 1.2% soluble coffee, which provides good solubility and good foam head generated at temperatures over 100° F. Foam stability in the beverage lasts for more than 20 min. Other aeration levels can be tested and this creamer formulation will be pourable at an overrun of less than about 115%. The foam head provided will have a height of about 2 cm to 3 cm for a conventional coffee cup or mug.

The term “about,” as used herein, should generally be understood to refer to both numbers in a range of numerals. Moreover, all numerical ranges herein should be understood to include each whole integer within the range. All percentages herein refer to weight rather than volume, where applicable and unless otherwise noted.

The term “substantially free,” as used herein, means that no more than about 10 weight percent, preferably no more than about 5 weight percent, and more preferably no more than about 1 weight percent of the material is present. In a preferred embodiment, “substantially free” means that no more than about 0.1 weight percent remains. Conversely, “substantially” as it refers to, e.g., dispersing or miscibility, and “substantially all,” typically means that at least 90 weight percent, preferably at least 95 weight percent, and more preferably at least about 99 weight percent, of the material referred to. “Entirely free” typically means that at most only a trace amount of the excluded material is present, and preferably, no detectable amount is present.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

1. A foamed liquid creamer comprising first and second components that cooperate when combined with a water-containing beverage to cream the beverage while forming a foam layer thereon, with a portion of the foam layer residing on the beverage and the remainder at least partly melting or dispersing in less than about 20 seconds after combination with the beverage to provide a whitening color and creamer flavor to the beverage.

2. The creamer of claim 1, wherein one of the components comprises a liquid whitening component while the other component comprises sufficient entrapped gas to facilitate foam formation, each component of which is refrigerator stable.

3. The creamer of claim 2, wherein the first and second components form a homogenized mixture that comprises water, vegetable oil, a protein component, and an emulsifier component to form the foamed creamer.

4. The creamer of claim 2, wherein the emulsifier component comprises at least one of a mono diglyceride, di-acetyl tartaric acid ester monoglyceride (DATEM), or stearoyl lactylate.

5. The creamer of claim 1, wherein the creamer can be spooned or squeezed onto or into a beverage but has a sufficiently thick viscosity that it cannot be poured.

6. The creamer of claim 1, wherein the creamer is pourable.

7. The creamer of claim 2, wherein the foam layer has a density that is less than that of the beverage so that the foam layer can reside upon the beverage and the liquid whitening component imparts a creaming effect and whitens the beverage and is uniformly dispersed within the beverage, and the entrapped gas helps lower the density of the foam layer and provide the foam.

8. The creamer of claim 1, wherein the beverage comprises tea, coffee, or chocolate, or a combination thereof.

9. The creamer of claim 2, in the form of a non-dairy creamer.

10. The creamer of claim 2, in the form of a dairy creamer.

11. The creamer of claim 2, wherein the first and second components are enclosed in one compartment of a single package and are refrigerator-stable.

12. A non-pressurized container comprising the creamer of claim 2.

13. A process for the manufacture of a foamed liquid creamer according to claim 2 which comprises:
chilling the creamer sufficiently so that it can retain a sufficient amount of gas to form a visible foam when combined with a beverage; and
incorporating at least the sufficient amount of gas into the creamer to create foaming and form the foamed liquid creamer.

14. The process of claim 13, which further comprises disposing the gas-foamed creamer in a non-pressurized container.

15. A vending machine that includes and dispenses a plurality of products at least one of which comprises the creamer of claim 1.

16. A method for providing a whitened beverage product having a perceived fresh upper foam layer which comprises:
combining with a water-containing beverage a liquid creamer that provides a foam in the beverage and disperses throughout the beverage to whiten the beverage after being combined therewith; and
allowing the foam to rise to form an upper foam layer on the beverage.

17. The method of claim 16, wherein the creamer disperses throughout the beverage in less than about 20 seconds after being combined therewith.

18. A ready-to-use, refrigerator-stable, foamed liquid creamer comprising a container and the creamer of claim 1.

19. The ready-to-use foamed liquid creamer of claim 18, wherein one of the components comprises a liquid whitening component while the other component comprises entrapped gas, and wherein the first and second components are refrigerator-stable.
